(19) United States
(12) Patent Application Publication
(10) Pub. No.: US 2026/0060176 A1
(43) Pub. Date: Mar. 5, 2026

(54) SENSOR ARRANGEMENT FOR DETECTING GRAINS IN A MATERIAL STREAM CONTAINING GRAINS AND NON-GRAIN COMPONENTS IN A COMBINE HARVESTER

(71) Applicant: DEERE & COMPANY, MOLINE, IL (US)

(72) Inventors: MARTIN UNTERPAINTNER, SAARBRUCKEN (DE); MARCO BROSCHART, HERSCHBERG (DE); MARTIN RITTERSHOFER, ZWEIBRUCKEN (DE)

(21) Appl. No.: 19/173,295

(22) Filed: Apr. 8, 2025

(30) Foreign Application Priority Data
Aug. 29, 2024 (EP) 24197127.4

(51) Int. Cl. A01D 41/127; G01N 21/84; G01N 21/85

(52) U.S. Cl. CPC A01D 41/1273; G01N 21/85; G01N 2021/845; G01N 2021/8466; G01N 2021/8592

(57) ABSTRACT

A sensor arrangement for detecting grains in a material stream that contains grains and non-grain components in a combine harvester (10) may include a conveying device. The conveying device may include an inlet and an outlet (74). A material stream may be formed in response to a rotating movement in the conveying device. The sensor arrangement may also include an electro-optical sensor arranged on the outer circumference of the conveying device and configured to view the material stream. The sensor arrangement may also include an electronic processing device for detecting grains in the material stream by using the signal from the electro-optical sensor. The electro-optical sensor may be arranged in the downstream region of the conveying device.

### CROSS-REFERENCE TO RELATED APPLICATIONS

This application claims priority to European Patent Application No. 24197127.4, filed Aug. 29, 2024, which is hereby incorporated by reference.

### FIELD OF THE DISCLOSURE

The disclosure relates to a sensor arrangement for detecting grains in a material stream containing grains and non-grain components for a combine harvester.

### BACKGROUND OF THE DISCLOSURE

Combine harvesters are used to harvest grain. The above-ground parts of plants, such as soybeans, maize, wheat, or oats, are cut off, gathered up, or stripped off or the inflorescences of the plants, such as maize or sunflowers, are severed and fed to a threshing and separation device in order to separate the fruit (the grain) from the remaining components of the harvested material. After the threshing and separating operation, there are still contaminants in the grain, such as straw particles and chaff. The mixture of grain and contaminants obtained during the threshing and separation is therefore fed to a cleaning system, which generally comprises an upper screen and a lower screen and optionally a preliminary screen.

While the cleaned grain is conveyed by an elevator into the grain tank after the cleaned grain has passed through the upper and lower screen, and the material discharged at the end of the lower screen (tailings) is subjected to a re-threshing operation. Material remaining at the end of the upper screen is discharged onto the field, be it by a chaff distributor or a shredding and distribution device for the non-grain material discharged from the separation device. In addition, the non-grain material remaining after the separation operation and discharged by the separation device is usually discharged onto the field, such as with a shredding and distribution device, or the non-grain material is deposited in a swath.

### SUMMARY OF THE DISCLOSURE

A sensor arrangement for detecting grains in a material stream that contains grains and non-grain components in a combine harvester may include a conveying device, which may include an inlet and an outlet and in which the material stream can be caused to make a rotating movement, an electro-optical sensor, which is arranged on an outer circumference of the conveying device and views the material stream, and an electronic processing device configured to detect grains in the material stream by using the signal from the electro-optical sensor. The electro-optical sensor may be arranged in the downstream region of the conveying device.

The conveying device rotates which, because of centrifugal force, results in a separating action of relatively heavy grains, on the one hand, and relatively lightweight other crop residues (e.g., chaff, straw particles), on the other hand, and which progresses further and further the longer and further the crop residual stream is in the rotating movement. The sensor may be attached in the vicinity of the outlet of the conveying device since, there, the separation between grain (also designated grains below) and other components of the crop residual stream is sufficiently advanced and is continued, which makes the optical distinction of grain and other components of the crop residual stream easier. In this way, the detection of grains, which represents lost grain, in the crop residual stream is improved.

In particular, the material stream may be fed axially to the conveying device and discharged tangentially at the outlet from the conveying device. The conveying device may include a rotating disk with entrainment means, e.g., a blade, attached thereto. An enclosure in which an outlet is left open may extend around the circumference of the disk, and the electro-optical sensor may interact with the material stream conveyed by the disk through an opening in the enclosure.

The electro-optical sensor may be arranged in a downstream half, in a downstream third, or in a downstream quarter of the enclosure.

The electro-optical sensor may be, in some instances, designed as a camera. The image signal from the camera may be evaluated by an image processing system in order to identify the grains. Other electro-optical sensors may be used, such as non-imaging sensors (e.g. near-infrared sensors) or imaging sensors such as laser scanners.

The conveying device may be a crop residue distributor, which may be a chaff distributor arranged downstream of a cleaning system or a discharge blower arranged downstream of a straw shredder. The conveying device may convey the tailings, and the sensor may be used for detecting grains in the tailings stream.

### BRIEF DESCRIPTION OF THE DRAWINGS

Implementations are described in more detail below with reference to the drawings. In the figures:

FIG. 1 shows a schematic side view of a combine harvester;

FIG. 2 shows a perspective view of a crop residue distributor; and

FIG. 3 shows a schematic top view of a crop residue distributor.

### DETAILED DESCRIPTION

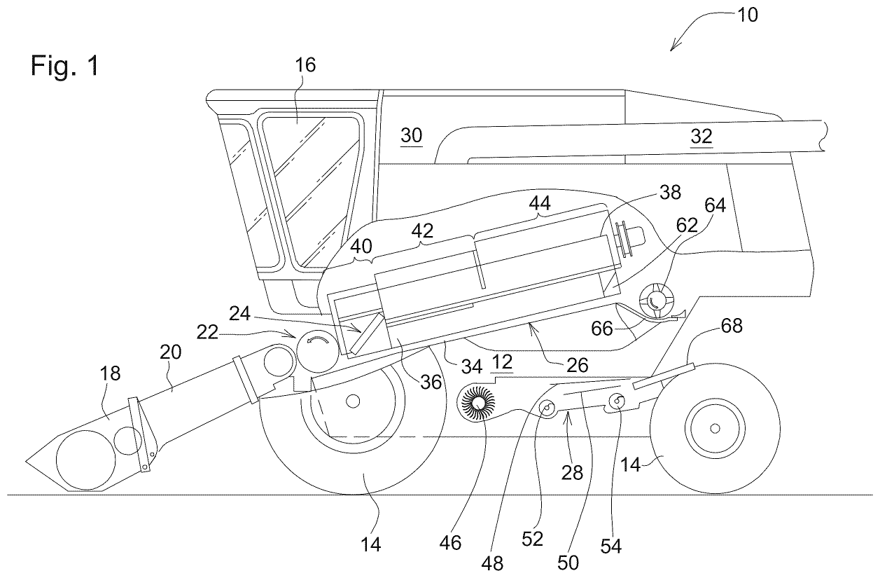

FIG. 1 shows an agricultural combine harvester 10 having a chassis 12 with wheels 14 engaging in the ground. The wheels 14 are fixed to the chassis 12 and are used to drive the combine harvester 10 forward in a forward direction. In FIG. 1, the forward direction runs to the left. The operation of the combine harvester 10 is controlled from the operator's cab 16. A cutting mechanism 18, e.g., an agricultural header, is used to harvest crop containing grain and to feed the harvested crop to a feeder house 20. The harvested material is fed through the feeder house 20 to a guide drum 22. The guide drum 22 guides the crop through an inlet transition section 24 to an axial crop processing device 26. In the following, directional statements, such as front and rear, are made with reference to the forward direction of the combine harvester 10, which runs to the left in FIG. 1.

The crop processing device 26 includes a rotor housing 34 and a rotor 36 arranged therein. The rotor 36 includes a hollow drum 38, to which material processing components for a charging section 40, the threshing section 42, and a separation section 44 are fastened. The charging section 40 is arranged on a front side of the crop processing device 26. In the longitudinal direction, the threshing section 42 and the separation section 44 are located downstream and rearward of the charging section 40. The drum 38 has the shape of a truncated cone in the charging section 40. The threshing section 42 includes a front section in the shape of a truncated cone and a cylindrical rear section. At an end of the axial crop processing unit 26 there is the cylindrical separation section 44 of the drum 38. Instead of an axial crop processing unit 26, a tangential threshing drum and an axial separation device following the threshing drum or straw walkers following the threshing drum can also be used.

Grain and chaff that fall through a threshing concave assigned to the threshing section 42 and a separator grate assigned to the separation section 44 are fed to a cleaning system 28 having a blower 46 and a slatted screen 48, 50 that may be vibrated. The cleaning system 28 removes the chaff and leads the clean grain via a screw conveyor 52 to an elevator for clean grain (not shown). The clean grain elevator deposits the clean grain into a grain tank 30. The clean grain in the grain tank 30 can be unloaded onto a grain cart, trailer, or truck by an unloading screw conveyor 32. Crop remaining at a rear end of the lower slatted screen 50 is fed to the crop processing device 26 again by means of a screw conveyor 54 and a tailings conveyor (not shown). The crop residues, which may include chaff and small straw particles, that are discharged at a rear end of the upper slatted screen 48 are distributed onto the field by a rotating crop residue distributor 68 arranged directly at the rear of the rear end of the upper slatted screen 48. The crop residues fall from above into the crop residue distributor 68, are accelerated there, and are discharged onto the field through lateral outlets.

Threshed straw leaving the separation section 44 is discharged from the crop processing device 26 through an outlet 62 and fed to a discharge drum 64. The discharge drum 64 interacting with the ground 66 arranged underneath the discharge drum 64 discharges the straw rearward. The straw can be shredded in a straw shredder and distributed onto the field by a straw distributor hood attached downstream of the straw shadow and having guide skids or driven discharge blowers arranged underneath.

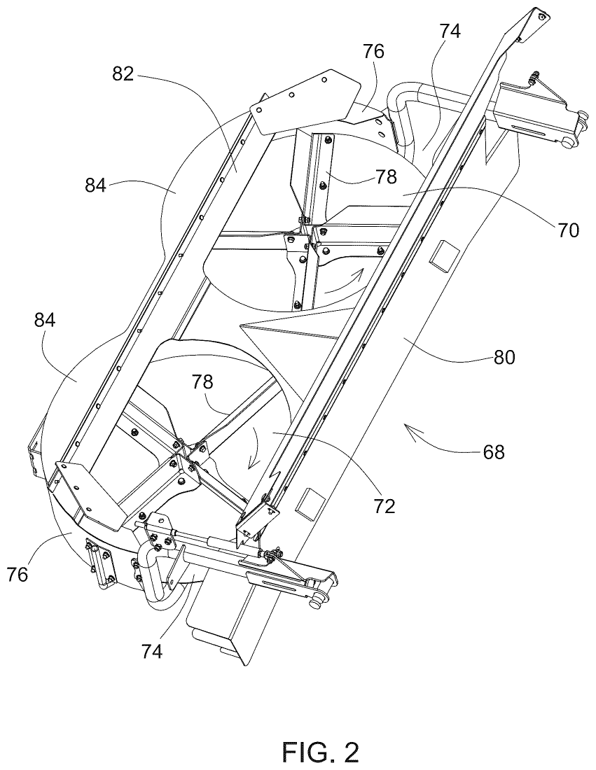

FIG. 2 shows a perspective view of the crop residue distributor 68, which may also be referred to as a chaff spreader or chaff distributor. The crop residue distributor 68 includes two disks 70, 72 arranged laterally beside each other and rotating about approximately vertical axes. The disks 70, 72 include entrainment means 78, e.g., blades, fastened thereto that extend approximately radially relative to the central axis of rotation of the disks 70, 72. The disks 70, 72 are rotated via mechanical or hydraulic or electric drivetrains, not shown, and, during operation, rotate in the directions indicated by the arrows. Accordingly, the left-hand disk 72 rotates in the clockwise direction, as seen from above, and the right-hand disk 70 rotates in the counterclockwise direction. The disks 70, 72 are arranged in a housing, which includes a rear cross member 80, a front cross member 82, and enclosures 76 in which lateral outlets 74 are left open, extending around the circumference of the disks 70, 72. The housing additionally includes upper coverings 84, which cover the disks 70, 72 toward the top in their regions located upstream of the front cross member 82.

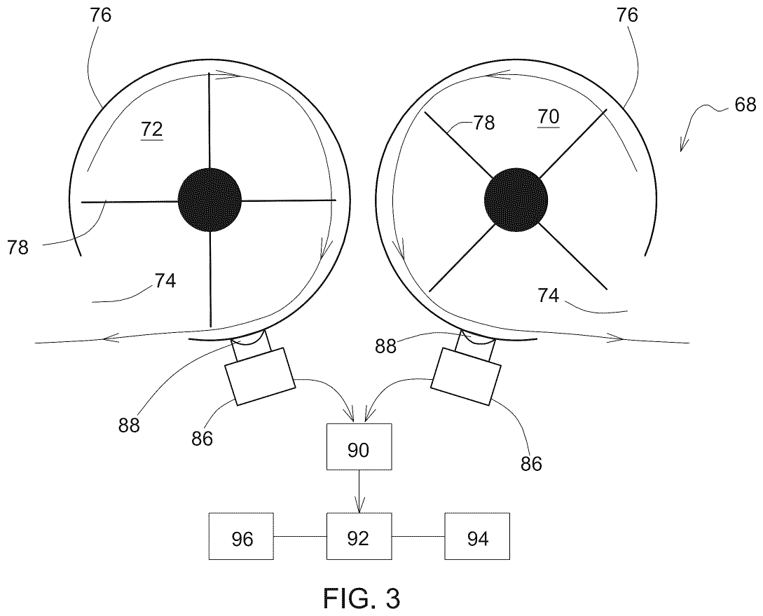

The crop residues discharged from the upper slatted screen 48 fall into the housing of the crop residue distributor 68 from above, move to the rear of the front cross member 82, and are accordingly fed to the disks 70, 72 axially (from above). The rotating disks 70, 72 accelerate the crop residues, and the crop residues leave the crop residue distributor 68 in a tangential direction through the lateral outlets 74, as can also be seen in FIG. 3. FIG. 3. shows the crop residue distributor 68 in a schematic top view.

Arranged in the downstream region of the enclosures 76 of the two disks 70, 72 are cameras 86, which look into the interior of the crop residue distributor 68 through windowpanes 88. The windowpanes 88 are arranged in cut-outs in the enclosures 76. During operation, the cameras 86 accordingly detect the crop residues which are conveyed by the disks 70, 72. The cameras 86 transmit their image signals to one or more image processing device(s) 90 equipped with processors that carry out processing of the image signals from the cameras 86 in order to detect lost grains contained in the crop residue stream conveyed and discharged by the crop residue distributor. The image processing device 90 is, in turn, connected to a controller 92, which, in turn, is connected to an operator interface 94. The grain losses can be indicated on the operator interface 94. In addition, the controller 92 can be connected to actuators 96 which control operating parameters of the cleaning system 28 on the basis of the determined grain losses. In particular, the operating parameters include an opening size of the slatted screen 48, an opening size of the slatted screen 50, a rotational speed of the blower 46, or a combination thereof.

The cameras 86 are arranged in the downstream regions of the enclosures 76 of the disks 70, 72, i.e., the immediate vicinity of the outlet 74. This has the advantage that the grains that have a greater mass density than the other crop residues (straw particles and chaff) gradually reach the outside to a greater extent than the other particles of the crop residues because of the action of the centrifugal force during the rotation of the disks, and the grains are accordingly successively concentrated on the outer circumference of the disks 70, 72 and on the enclosures 76. This concentration rises during the rotation and is at the greatest at the outlet 74. As a result of the rotation of the disks 70, 72, separation between heavier grains and lighter other particles of the crop residue stream takes place. This arrangement of the cameras 86 make use of this behavior, since the detection of the concentrated grains in the vicinity of the downstream end of the enclosure 76 is more easily possible than further upstream, where the grains are less concentrated. The cameras 86 are arranged in particular in the downstream half. In some instances, the cameras 86 are arranged in the downstream third of the enclosures 76. In some instances, the cameras 86 are arranged in the downstream quarter of the enclosures 76. In some instances, the cameras 86 are positioned immediately adjacent to the downstream end of the enclosures 76, such as adjacent to, the outlet 74. The cameras 86 and the image processing device 90 can be used instead of previous loss sensors (baffle plates, etc.) to detect and count the impinging grains. The cameras 86 and the image processing device 90 can be used in addition to other loss sensors, such as baffle plates or other loss sensors, installed in the combine harvester, and the cameras 86 and the image processing device 90 can be used to calibrate the other loss sensors detecting the impinging grains. A sensor arrangement, as described herein, provides improved detection of grains in a material stream that contains grains and non-grain components in a combine harvester.

For example, sensor arrangements described herein provide improved grain loss sensing compared to baffle plate sensors, because baffle plate sensors that detect absolute values for the grain numbers depend on a series of parameters which may be unknown, such as the throughput and properties of the crop, such as moisture, density and dimensions of the grains. Further, baffle plate sensors have to be calibrated from time to time in a time-consuming manner or by means of a separate arrangement for collecting, cleaning, and weighing the crop residues ejected onto the field from the combine harvester.

It should further be noted that the positioning of the cameras 86 indicated in FIG. 3 could also be carried out with the same effect on discharge blowers, such as discharge blowers arranged downstream of a straw shredder, as shown, for example, in EP 2 250 868 A1 and US 2022/0394925 A1, the disclosures of which are hereby included by reference. The cameras 86 would then detect the lost grains in the crop residual stream that is supplied to the discharge blower from the threshing and separation device (crop processing unit 26), from the cleaning system 28, or both, depending on the operating mode of the respective (shredder or swath) deposition.

The signals from the cameras 86 can be evaluated by the image processing device 90 not only with regard to the lost grains, but it is also possible for other information to be obtained from the images of the cameras 86. For example, the image processing device 90 may detect the proportion of broken grains in a material stream using the signals from the cameras 86. This information in regard to the proportion of broken grains could be indicated to the operator or used for the automatic control of working parameters of the crop processing device 26, for example, for adjusting the threshing gap, predefining the rotational speed of the threshing device, for controlling the forward drive speed, or a combination of these.

1. A sensor arrangement configured to detect grains in a material stream that contains grains and non-grain components in a combine harvester, the sensor arrangement comprising:
a conveyor that includes:
an inlet; and
an outlet, the conveyor configured to produce rotation of a material stream contained therein,
an electro-optical sensor arranged on an outer circumference of the conveying device and configured to view the material stream, and
an electronic processing device configured to detect grains in the material stream using a signal from the electro-optical sensor,
wherein the electro-optical sensor is arranged in a downstream region of the conveying device.

2. The sensor arrangement of claim 1, wherein the material stream is fed axially to the conveying device and is discharged tangentially at the outlet from the conveying device.

3. The sensor arrangement of claim 2, wherein the conveying device includes a rotating disk with a blade attached thereto, wherein the conveyor includes an enclosure, wherein an outlet is formed in the enclosure and extends around at least a portion of a circumference of the disk, and wherein the electro-optical sensor senses the material stream conveyed by the disk through an opening formed in the enclosure.

4. The sensor arrangement of claim 3, wherein the electro-optical sensor is arranged in a downstream half, a downstream third, or a downstream quarter of the enclosure.

5. The sensor arrangement of claim 1, wherein the electro-optical sensor is a camera.

6. The sensor arrangement of claim 1, wherein the conveying device is a crop residue distributor.

7. The sensor arrangement of claim 6, wherein the crop residue distributor is a chaff distributor arranged downstream of a cleaning system or a discharge blower arranged downstream of a straw shredder.

8. A combine harvester comprising:
a chassis;
wheels coupled to the chassis;
a crop processing device configured to process crop material;
a conveyor configured to receive crop residue from the crop processing device, the conveyor including:
a housing defining an outer circumference, the housing including:
an inlet configured to receive the crop residue; and
an outlet configured to discharge the crop residue, the conveyor configured to produce a material stream from the crop residue received into the housing; and
a sensor arrangement including:
an electro-optical sensor arranged on the outer circumference of the housing and configured to view the material stream and generate a signal, and
an electronic processing device configured to process the signal to detect grains in the material stream,
wherein the electro-optical sensor is arranged at a downstream region of the housing.

9. The combine harvester of claim 8, wherein the crop material is fed axially to the housing and is discharged tangentially at the outlet from the housing.

10. The combine harvester of claim 9, wherein the conveyor includes a rotatable disk that includes a blade,
wherein the disk is disposed in an enclosure of the housing;
wherein an outlet extends around at least a portion of a circumference of the disk, and
wherein the electro-optical sensor senses the material stream conveyed by the disk through an opening formed in the enclosure.

11. The combine harvester of claim 10, wherein the electro-optical sensor is arranged in a downstream half, a downstream third, or a downstream quarter of the enclosure.

12. The combine harvester of claim 8, wherein the electro-optical sensor is a camera.

13. The combine harvester of claim 8, wherein the conveyor is a crop residue distributor.

14. The combine harvester of claim 13, wherein the crop residue distributor is a chaff distributor arranged downstream of a cleaning system or a discharge blower arranged downstream of a straw shredder.
